(19) United States
(12) Patent Application Publication
(10) Pub. No.: US 2026/0171043 A1
(43) Pub. Date: Jun. 18, 2026

(54) DISLAY DEVICE

(71) Applicant: Japan Display Inc., Tokyo (JP)

(72) Inventor: Tadayoshi KATSUTA, Tokyo (JP)

(21) Appl. No.: 19/396,448

(22) Filed: Nov. 21, 2025

(30) Foreign Application Priority Data
Dec. 18, 2024 (JP) 2024-221325

(51) Int. Cl. G09G 3/36

(52) U.S. Cl. CPC G09G 3/3677; G09G 3/3688; G09G 2310/0286; G09G 2320/0233; G09G 2320/0252

(57) ABSTRACT

A display device includes a plurality of gate lines, a plurality of signal lines, a plurality of pixels, a display gate driver that sequentially scans the plurality of gate lines, and a precharging gate line selecting unit that selects the plurality of gate lines en bloc. One frame includes a precharging period in which the precharging gate line selecting unit selects the plurality of gate lines en bloc, and a precharging gradation signal is written to the plurality of pixels from the plurality of signal lines, a first period in which, after the precharging period, the display gate driver sequentially scans the plurality of gate lines, and gradation signals corresponding to a video signal are written to the plurality of pixels from the plurality of signal lines, and a second period in which none of the plurality of gate lines is selected after the first period.

### CLAIM OF PRIORITY

The present application claims priority from Japanese Patent Application JP 2024-221325 filed on Dec. 18, 2024, the contents of which is hereby incorporated by reference into this application.

### BACKGROUND OF THE INVENTION

### (1) Field of the Invention

The present disclosure relates to a display device.

### (2) Description of the Related Art

JP-2010-091967-A, for example, has been proposed as an electrooptic device that suppresses moving image blurriness.

### SUMMARY OF THE INVENTION

A method is known which uses the following two methods in combination with each other in order to significantly improve moving image characteristics on a liquid crystal panel. A first method is high frequency driving (method of raising a frame frequency is adopted). A second method is impulse driving using a blinking backlight (which method is referred to also as a backlight blinking method; a method of performing impulse driving by turning off the backlight while synchronizing scanning timing is adopted).

However, liquid crystal molecules themselves have a response speed upper limit value. Thus, raising the frame frequency to a liquid crystal molecule response speed or higher does not lead to an improvement in moving image characteristics, but invites an image quality degradation such as luminance nonuniformity.

It is an object of the present disclosure to provide a technology that enables an improvement in moving image characteristics.

Other problems and novel features will become apparent from the description of the present specification and the accompanying drawings.

A summary of representatives of the present invention will be briefly described as follows.

That is, a display device includes: a plurality of gate lines extending in a first direction and juxtaposed to each other in a second direction intersecting the first direction; a plurality of signal lines extending in the second direction and juxtaposed to each other in the first direction; a plurality of pixels arranged in a form of a matrix in the first direction and the second direction; a display gate driver configured to sequentially scan the plurality of gate lines; and a precharging gate line selecting unit configured to select the plurality of gate lines en bloc. In the display device, one frame includes: a precharging period in which the precharging gate line selecting unit selects the plurality of gate lines en bloc, and a precharging gradation signal is written to the plurality of pixels from the plurality of signal lines; a first period in which, after the precharging period, the display gate driver sequentially scans the plurality of gate lines, and gradation signals corresponding to a video signal are written to the plurality of pixels from the plurality of signal lines; and a second period in which, after the first period, none of the plurality of gate lines is selected.

### BRIEF DESCRIPTION OF THE DRAWINGS

FIG. 1 is a diagram of assistance in explaining a first driving method of a display device according to a comparative example;

FIG. 2 is a schematic diagram of assistance in explaining an example of display with an image quality degradation;

FIG. 3 is a diagram of assistance in explaining a second driving method of the display device according to the comparative example;

FIG. 4 is a diagram illustrating an example of a configuration of a display device according to a first embodiment;

FIG. 5 is a diagram of assistance in explaining gradation signals supplied to the display device according to the first embodiment;

FIG. 6 is a diagram of assistance in explaining timings of the display device according to the first embodiment;

FIG. 7 is a diagram of assistance in explaining an example of a circuit configuration of logic circuits (GL1 and GD1) in FIG. 4;

FIG. 8 is a diagram of assistance in explaining timings of the logic circuits (GL1 and GD1) in FIG. 7;

FIG. 9 is a diagram illustrating an example of a configuration of a display device according to a first modification;

FIG. 10 is a diagram of assistance in explaining timings of the display device according to the first modification;

FIG. 11 is a diagram illustrating an example of a configuration of a display device according to a second modification;

FIG. 12 is a plan view schematically illustrating a first configuration example of a display device according to a third modification;

FIG. 13 is a plan view schematically illustrating a second configuration example of the display device according to the third modification;

FIG. 14 is a diagram of assistance in explaining an example of a circuit configuration corresponding to the second configuration example of the display device of FIG. 13;

FIG. 15 is a diagram illustrating a configuration example in which an en bloc precharging period is divided into halves;

FIG. 16 is a diagram illustrating a configuration example in which the en bloc precharging period is divided into thirds; and

FIG. 17 is a diagram illustrating a configuration example in which the number of signal systems of an internal reset signal Int-XRST is increased according to the number of divisions of the en bloc precharging period.

### DETAILED DESCRIPTION OF THE PREFERRED EMBODIMENTS

Embodiments of the present invention will hereinafter be described with reference to the drawings.

It is to be noted that the disclosure is only a mere example, and that appropriate changes that can be easily made by those skilled in the art while the spirit of the invention is maintained are naturally included in the scope of the present invention. In addition, in order to make the description clearer, the drawings may illustrate the widths, thicknesses, shapes, and the like of respective parts schematically as compared with actual modes. However, the widths, thicknesses, shapes, and the like of the respective parts are a mere example, and do not limit the interpretation of the present invention.

In addition, in the present specification and the drawings, elements similar to those described earlier with reference to preceding drawings are identified by the same reference numerals, and detailed description thereof may be omitted as appropriate.

In a present embodiment, a liquid crystal display device will be disclosed as an example of a display device. The liquid crystal display device can be used in various devices such as an augmented reality/virtual reality/mixed reality (AR/VR/MR) terminal, a smart phone, a tablet terminal, a mobile telephone terminal, a personal computer, a television receiver, a vehicle-mounted device, and a game apparatus.

The “display device” refers to a display device in general that displays video by using a display panel. The “display panel” refers to a structural body that displays video by using an electrooptic layer. For example, the term “display panel” may refer to a display cell including the electrooptic layer, or may refer to a structural body fitted with a semiconductor apparatus in which other optical members (for example, a polarizing member, a backlight, a touch panel, and the like) and driving circuits such as a source driver integrated circuit (IC) are provided for the display cell. Here, the “electrooptic layer” can include a liquid crystal layer, an electrochromic (EC) layer, and the like as long as no technical contradiction occurs. Hence, in the embodiment to be described later, a description will be made by illustrating a liquid crystal panel including a liquid crystal layer as the display panel. However, applications to display panels including the other electrooptic layers described above are not excluded.

### Embodiment

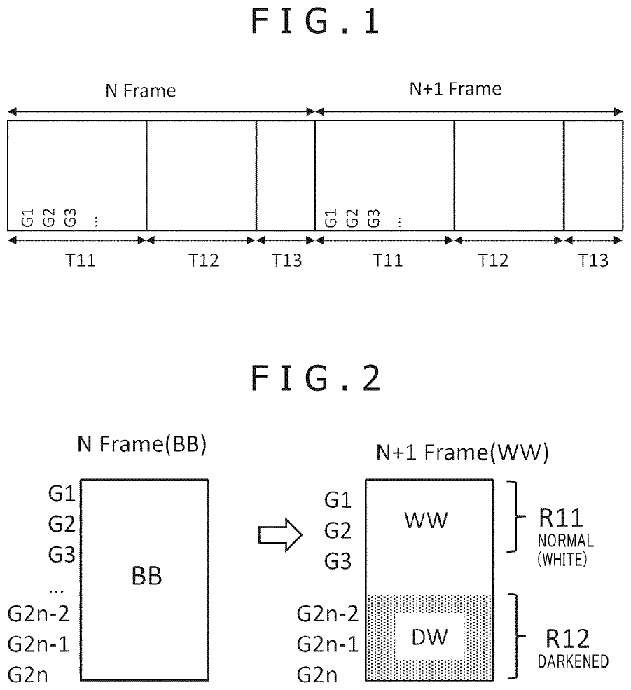

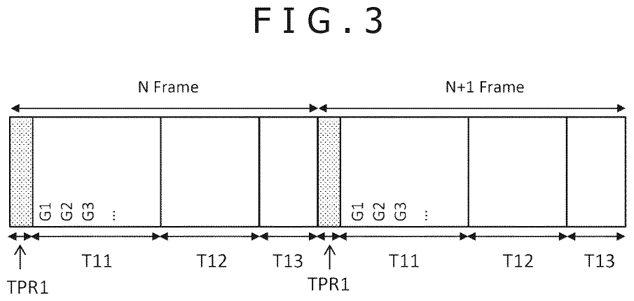

Problems will first be described with reference to FIG. 1, FIG. 2, and FIG. 3. FIG. 1 is a diagram of assistance in explaining a first driving method of a display device according to a comparative example. FIG. 2 is a schematic diagram of assistance in explaining an example of display with an image quality degradation. FIG. 3 is a diagram of assistance in explaining a second driving method of the display device according to the comparative example.

FIG. 1 illustrates driving periods in each of an Nth frame (N Frame) and an (N+1)th frame (N+1 Frame) following the N Frame in the display panel. The following periods are illustrated as driving periods in each frame.

1) First period T11: a first period T11 is a period in which gate lines (referred to also as scanning lines: G1, G2, G3, . . . ) are sequentially scanned (Scan) and set in a selected state, and gradation signals (gradation potentials) corresponding to a video signal are written from signal lines to a plurality of pixels of one line (one row) connected to a gate line in a selected state.
2) Second period T12: a second period T12 is a liquid crystal molecule response period based on the response speed of liquid crystal molecules of the pixels to which the gradation signals have been written.
3) Third period T13: a third period T13 is a period of displaying an image based on the gradation signals written to all of pixels within the display panel by illuminating the backlight.

Here, the liquid crystal molecules themselves have a response speed upper limit value. Thus, raising a frame frequency to the liquid crystal molecule response speed or higher does not lead to an improvement in moving image characteristics, but invites an image quality degradation such as luminance nonuniformity.

FIG. 2 schematically illustrates an image quality degradation in a case of performing driving with the frame frequency set at a high frequency equal to or higher than the liquid crystal molecule response speed. Suppose that a display panel DISP includes, for example, 2n gate lines G1, G2, G3, . . . , G2n-2, G2n-1, and G2n, and is sequentially scanned in order of G1, G2, G3, . . . , G2n-2, G2n-1, and G2n. The present example represents a case where the N Frame displays a black screen (BB), and the N+1 Frame is intended to display a white screen (WW).

For example, in a display panel region R11 of gate lines scanned relatively early, such as gate lines G1, G2, and G3, there is a sufficient liquid crystal molecule response period, and therefore a normal white color (WW) is displayed. On the other hand, in a display panel region R12 of gate lines scanned later, such as, for example, gate lines G2n-2, G2n-1, and G2n, there is not a sufficient liquid crystal molecule response period, and therefore the screen is slightly darkened (dark white color (DW) is displayed) without the normal white color (WW) being displayed.

That is, when the liquid crystal molecule response period T12 becomes insufficient in the case of raising the frame frequency to the liquid crystal molecule response speed or higher, liquid crystal response is not made in time and an intended luminance is not achieved in a region corresponding to a second half of gate line scanning (second half part of the display panel: a display panel region corresponding to gate lines that constitute a second half in scanning order).

A method for solving this problem is known which provides a period TPR1 in which all of the pixels are precharged en bloc with a gradation signal corresponding to a gray color (Gray), for example, as a halftone before the first period T11, as illustrated in FIG. 3. That is, as a measure, a method is known which precharges pixel capacitances (Cs) and liquid crystal capacitances (Clc) in all of the pixels, for example, with a Gray potential en bloc to make liquid crystal response to white, black, or another gradation Gray completed early in the subsequent liquid crystal response period. In this case, however, a dedicated source driver IC capable of that driving needs to be fabricated.

### First Embodiment

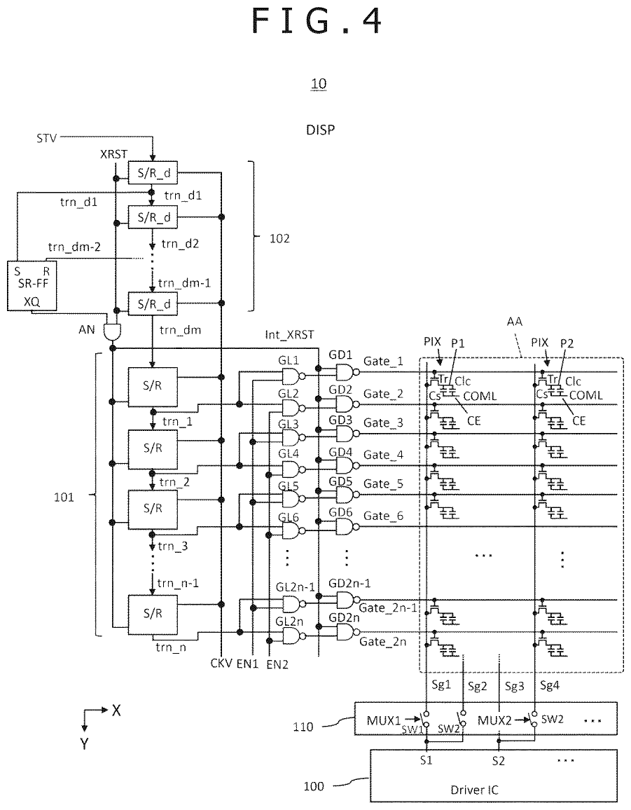

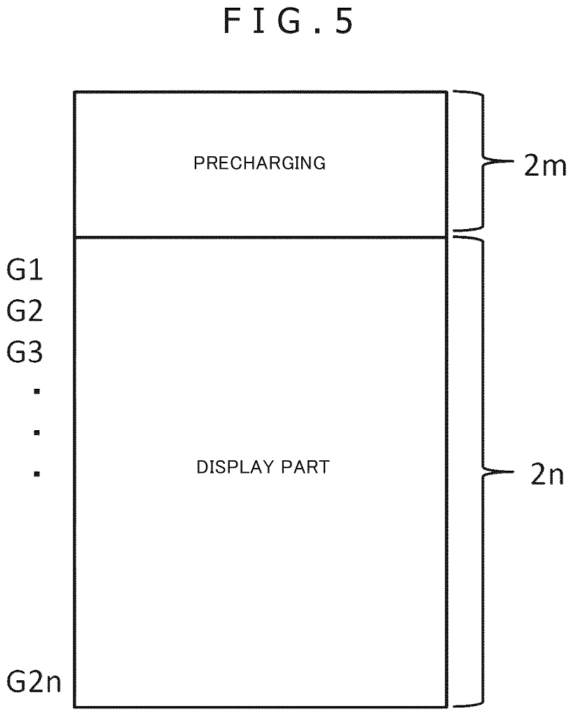

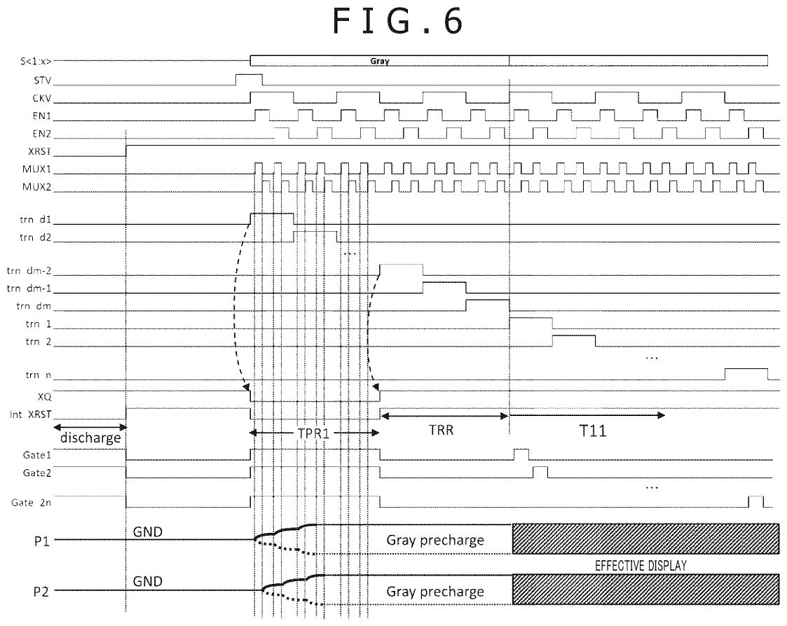

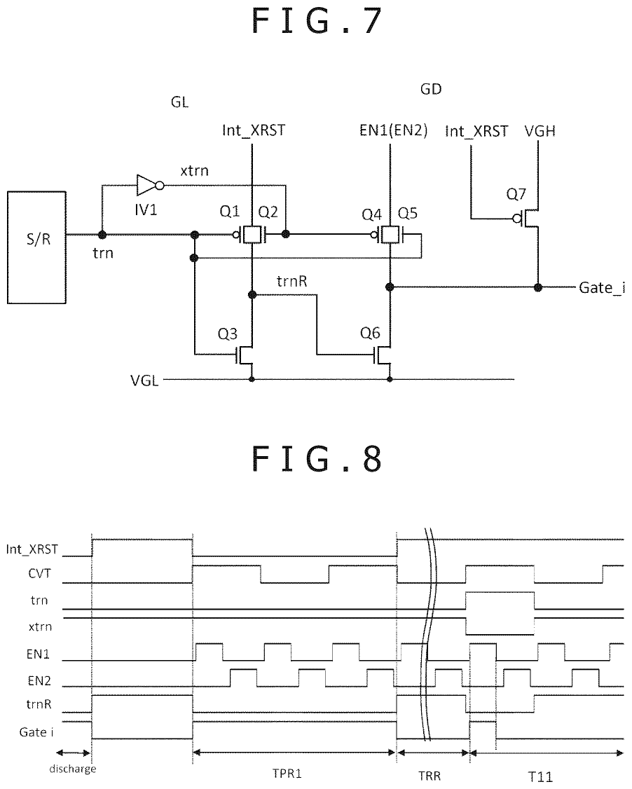

A display device according to a first embodiment will next be described with reference to FIG. 4, FIG. 5, FIG. 6, FIG. 7, and FIG. 8.

FIG. 4 is a diagram illustrating an example of a configuration of the display device according to the first embodiment. FIG. 5 is a diagram of assistance in explaining gradation signals supplied to the display device according to the first embodiment. FIG. 6 is a diagram of assistance in explaining timings of the display device according to the first embodiment. FIG. 7 is a diagram of assistance in explaining an example of a circuit configuration of logic circuits (GL1 and GD1) in FIG. 4. FIG. 8 is a diagram of assistance in explaining timings of the logic circuits (GL1 and GD1) in FIG. 7.

As illustrated in FIG. 4, the display device 10 includes a display panel DISP and a source driver (Driver IC) 100. The display panel DISP includes an active region (display region) AA provided with a plurality of gate lines, a plurality of signal lines, and a plurality of pixels, a display gate driver (Gate Driver) 101, and a precharging additional shift register 102. The active region AA has a plurality of pixels PIX formed therein which are arranged in a matrix manner (in a form of a matrix) along a first direction X and a second direction Y intersecting the first direction X. The plurality of pixels PIX include, for example, a plurality of pixels PIX for red R, a plurality of pixels PIX for blue B, and a plurality of pixels PIX for green G. In the present example, depicted as a representative example are a plurality of pixels PIX arranged in a form of a matrix of 2n rows and 4 columns, that is, pixels including four pixels in the first direction X (a horizontal direction or a row direction) and 2n pixels in the second direction Y (a vertical direction or a column direction) intersecting the first direction X. The precharging additional shift register 102 can be reworded as a precharging gate line selecting unit, or can be reworded as a part of the display gate driver.

The active region AA has a plurality of gate lines (Gate_1, Gate_2, . . . , Gate_2n) arranged so as to extend along the first direction X and arrayed so as to be juxtaposed to each other in the second direction Y. The gate line Gate_1 is connected with a plurality of pixels of a first row. Similarly, each of the gate lines (Gate_2, . . . , Gate_2n) is connected with a plurality of pixels connected to a corresponding row. The gate lines can be reworded as scanning lines.

In addition, the active region AA has a plurality of signal lines Sig (Sg1, Sg2, Sg3, and Sg4) arranged so as to extend along the second direction Y and arrayed so as to be juxtaposed to each other in the first direction X. The signal line Sg1 is connected with a plurality of pixels of a first column. Similarly, each of the signal lines Sg2, Sg3, and Sg4 is connected with a plurality of pixels connected to a corresponding column. The signal lines can be reworded as source lines. FIG. 4 discloses four signal lines by way of illustration. However, other signal lines may be provided on a side of Sg4.

A thin film transistor is used as a switching element Tr provided to each of the pixels PIX. A bottom gate type transistor or a top gate type transistor may be used as an example of the thin film transistor. A single gate thin film transistor will be illustrated as the switching element Tr. However, a double gate transistor may be used. One of a source electrode and a drain electrode of the switching element Tr is connected to the signal line Sig (Sg1, Sg2, Sg3, or Sg4). A gate electrode of the switching element Tr is connected to the gate line Gate_i (i=1, 2, . . . , 2n) as a scanning line. The other of the source electrode and the drain electrode is connected to a pixel electrode (P1 or P2). The pixel electrode faces a common electrode (CE) with a liquid crystal LC interposed therebetween. The common electrode (CE) is connected to common potential wiring COML. The liquid crystal LC forms a capacitance Clc with the pixel electrode and the common electrode as a pair of capacitance electrodes. In addition, a storage capacitor Cs is formed between the pixel electrode (P1 or P2) and the common electrode (CE) with a dielectric such as an insulating film interposed therebetween. Incidentally, the common potential wiring COML is supplied with a common voltage VCOM from a common potential driving circuit.

The display gate driver 101 includes a plurality of shift registers S/R, gate line selecting circuits GL1 to GL2n, and gate line driving circuits GD1 to GD2n. The additional shift register 102 includes a plurality of shift registers S/R_d, a set-reset flip-flop SR-FF, and an AND circuit AN. Each of the gate line selecting circuits GL1 to GL2n and the gate line driving circuits GD1 to GD2n can be formed by a NAND circuit.

The additional shift register 102 is provided to generate a precharging timing signal. A first shift register S/R_d has an input terminal supplied with a start pulse STV, a clock terminal supplied with a transfer clock CKV, a reset signal terminal supplied with a reset signal XRST, and an output terminal from which a transfer signal trn_d1 is output.

As with the first shift register S/R_d, second to (m)th shift registers S/R_d have an input terminal, a clock terminal supplied with the transfer clock CKV, a reset signal terminal supplied with the reset signal XRST, and an output terminal from which a corresponding transfer signal trn_dn (n=2, . . . , m) is output. Each of the input terminals of the second to (m)th shift registers S/R_d is supplied with a transfer signal trn_dx from the shift register S/R_d in a preceding stage.

As with the first shift register S/R_d, the second to (m)th shift registers S/R_d are supplied with the transfer clock CKV and the reset signal XRST. The transfer signal trn_d1 as the output of the first shift register S/R_d is supplied to the second shift register S/R_d. A transfer signal trn_d2 as the output of the second shift register S/R_d is supplied to the third shift register S/R_d. Similarly, transfer signals trn_d3 to trn_dm-1 as the outputs of the third to (m-1)th shift registers S/R_d are supplied to the shift registers S/R_d in the following stages. A transfer signal trn_dm as the output of the (m)th shift register S/R_d is supplied to a first shift register S/R of the plurality of shift registers S/R within the display gate driver 101.

When the start pulse STV changes from a low level to a high level and the transfer clock CKV changes from a low level to a high level while the first shift register S/R_d is receiving the reset signal XRST having a high level, the first shift register S/R_d generates the transfer signal trn_d1, and supplies the transfer signal trn_d1 to the second shift register S/R_d.

When the transfer clock CKV changes from the high level to the low level, the second shift register S/R_d generates the transfer signal trn_d2, and supplies the transfer signal trn_d2 to the third shift register S/R_d. Thus, the transfer signal trn_dx (x=1, . . . , m) is configured to be sequentially transferred to the shift registers S/R_d. A signal that can define (identify) an en bloc precharging period is generated by using the start pulse STV and two arbitrary signals from among the transfer signals (trn_dx) of the additional shift registers S/R_d.

In FIG. 4, the set-reset flip-flop (SR-FF) has a set terminal S supplied with the transfer signal trn_d1, has a reset terminal R supplied with the transfer signal trn_dm-2, and generates an output signal XQ. The output signal XQ makes a transition from a high level to a low level when the transfer signal trn_d1 makes a transition to a high level. Then, the output signal XQ makes a transition from the low level to the high level when the transfer signal trn_dm-2 makes a transition to a high level. A low level period of the output signal XQ is the en bloc precharging period. Here, en bloc means that all of the gate lines (Gate_1, . . . , Gate_2n) are set at a selection level (high level: H), and the pixel electrodes (P1 and P2) are precharged en bloc with a desired gradation potential.

The AND circuit AN is supplied with the reset signal XRST and the output signal XQ, and generates an internal reset signal Int-XRST by obtaining a logical product of the reset signal XRST and the output signal XQ. A low level of the internal reset signal Int-XRST in the present example indicates a discharging (Discharge) period of the pixel electrodes (P1 and P2) or the en bloc precharging period of the pixel electrodes (P1 and P2). The precharging additional shift register 102, the set-reset flip-flop (SR-FF), and the AND circuit AN described above can be collectively referred to as a precharging setting circuit.

The plurality of shift registers S/R within the display gate driver 101 have a reset terminal supplied with the internal reset signal Int-XRST and a clock terminal supplied with the transfer clock CKV. The first shift register S/R among the plurality of shift registers S/R has an input terminal supplied with the transfer signal trn_dm and an output terminal that generates a transfer signal trn_1 and supplies the transfer signal trn_1 to a second shift register S/R. Similarly, second to (n-1)th shift registers S/R have an input terminal supplied with the transfer signal trn_1 to trn_n-2 and an output terminal that generates a transfer signal trn_2 to trn_n-1, and supplies the transfer signal trn_2 to trn_n-1 to a shift register S/R in a corresponding next stage. An (n)th shift register S/R has an output terminal that generates and outputs a transfer signal trn_n.

Of the gate line selecting circuits GL1 to GL2n, gate line selecting circuits GL1, GL3, GL5, . . . , GL2n-1 have a first input terminal made to receive a first enable signal EN1, and gate line selecting circuits GL2, GL4, GL6, . . . , GL2n have a first input terminal made to receive a second enable signal EN2. In addition, the gate line selecting circuits GL1 and GL2 have a second input terminal made to receive the transfer signal trn_1, and the gate line selecting circuits GL3 and GL4 have a second input terminal made to receive the transfer signal trn_2. Similarly, the gate line selecting circuits GL5, GL6, . . . , GL2n-1, GL2n have a second input terminal made to receive the transfer signal trn_3, . . . , trn_n. Respective output terminals of the gate line selecting circuits GL1 to GL2n are connected to respective second input terminals of the gate line driving circuits GD1 to GD2n.

Respective first input terminals of the gate line driving circuits GD1 to GD2n are connected so as to receive the internal reset signal Int-XRST. Respective output terminals of the gate line driving circuits GD1 to GD2n are connected to the gate lines (Gate_1, . . . , Gate_2n), respectively.

A multiplexer 110 is provided between the plurality of signal lines Sig and the source line driver (driver IC) 100. The multiplexer 110 is configured to include a plurality of first switches SW1 controlled to be on or off according to the level of a first selection signal MUX1 and a plurality of second switches SW2 controlled to be on or off according to the level of a second selection signal MUX2.

The source line driver 100 includes a plurality of source line terminals S1, S2, . . . for supplying gradation signals to the plurality of signal lines Sig. The multiplexer 110 and the source line driver 100 can be reworded as a signal line driving circuit that supplies the gradation signals to the plurality of signal lines.

A first source line terminal S1 is connected to the signal line Sg1 via a first switch SW1, and is connected to the signal line Sg2 via a second switch SW2. A second source line terminal S2 is connected to the signal line Sg3 via a first switch SW1, and is connected to the signal line Sg4 via a second switch SW2. Other source terminals not depicted in FIG. 4 are similarly connected to a signal line (Sgm) via a first switch SW1, and are connected to a signal line (Sgm+1) via a second switch SW2.

In the display device 10 of FIG. 4, the gate line driving circuits GD1 to GD2n can set all of the gate lines (Gate_1, . . . , Gate_2n) in a selected state according to the low level of the internal reset signal Int-XRST generated by the additional shift register 102. The source line driver 100 is configured to, at this time, supply a precharging gradation signal (gradation potential) to the plurality of signal lines Sig (Sg1, Sg2, Sg3, Sg4, . . . ), and thereby charge the pixel electrodes (P1, P2, . . . ) of all of the pixels PIX in advance by using the precharging gradation signal. Here, the precharging gradation signal can be reworded as a third gradation signal between a first gradation signal corresponding to a black color and a second gradation signal corresponding to a white color. The precharging gradation signal can be, for example, set as a gradation signal corresponding to a gray (Gray).

Thus, for example, the pixel electrodes (P1, P2, . . . ) of all of the pixels PIX are precharged en bloc with the gradation signal corresponding to the gray (Gray) in advance, so that liquid crystal response to a gradation signal of a white color, a gradation signal of a black color, or a gradation signal corresponding to another gradation Gray can be completed early in the subsequent liquid crystal response period T12. Hence, a technology that enables an improvement in moving image characteristics can be provided.

FIG. 5 is a diagram of assistance in explaining a precharging period and a display period. Specifications of the signal output of the source line driver 100 are preferably as follows. A maximum number of vertical display stages (number of rows) in the precharging period represents a period of double the number m of stages of the plurality of shift registers S/R_d included in the additional shift register 102 (2m). The source line driver 100 preferably has such specifications as to be able to supply the precharging gradation signal to the plurality of signal lines Sig in this period. In addition, the number of vertical display stages (number of rows) in the display period is the number 2n of the gate lines (Gate_1, . . . , Gate_2n). The source line driver 100 supplies gradation signals for display to the plurality of signal lines Sig in this period.

Hence, at a time of generating a video signal of a moving image or the like by a data processing device or the like, a video signal for the 2(m+n) vertical stages is set, the precharging gradation signal is set for the first 2m stages, and a video signal of an actual moving image or the like to be displayed on the display panel DISP is set for the subsequent 2n stages.

Incidentally, FIG. 4 and FIG. 5 represent an example of (m+n) stages of shift registers (S/R_d and S/R) and two systems of enable signals (EN1 and EN2). In a case of (m+n) stages of shift registers (S/R_d and S/R) and four systems of enable signals, a video signal (including the precharging gradation signal) for 4(m+n) stages needs to be prepared. In a case of (m+n) stages of shift registers (S/R_d and S/R) and one system of an enable signal, a video signal (including the precharging gradation signal) for (m+n) stages needs to be prepared. However, the specifications of the source line driver 100 do not depend on the specifications of the number of systems of enable signals.

Operation of the display device 10 will next be described with reference to FIG. 6. In FIG. 6, S<1: x> denotes states of the source line terminals S1, S2, . . . S<1:x>, the start pulse STV, the transfer clock CKV, the reset signal XRST, the first enable signal EN1, the second enable signal EN2, the first selection signal MUX1, and the second selection signal MUX2 are signals supplied from the outside of the display device 10. Signals other than the above are internal signals of the display device 10 (display panel DISP). Here, as described with reference to FIG. 3, one frame in the display device 10 includes an en bloc precharging period TPR1, a first period T11, a second period T12, and a third period T13. The en bloc precharging period TPR1 and the first period T11 will be mainly described with reference to FIG. 6.

First, the reset signal XRST is set to a low level, the internal reset signal Int-XRST is set to a low level, and the discharging of the pixel electrodes (P1 and P2) of all of the pixels PIX (discharge) is performed. At this time, the pixel electrodes (P1 and P2) in the present example are set to a ground potential (GND) such as 0 V. After completion of the discharging (discharge), the reset signal XRST and the internal reset signal Int-XRST are set to a high level.

Thereafter, the first shift register S/R_d is supplied with the start pulse STV that changes in a pulse manner only once. The first shift register S/R_d is then supplied with the transfer clock CKV. In addition, the first enable signal EN1 and the second enable signal EN2 start to be supplied.

On the basis of the high level of the start pulse STV and the high level of the transfer clock CKV, the first shift register S/R_d generates the transfer signal trn_d1 having a high level, and supplies the transfer signal trn_d1 to the second shift register S/R_d. The output signal XQ of the set-reset flip-flop (SR-FF) is changed from a high level to a low level on the basis of the high level of the transfer signal trn_d1 having the high level. The internal reset signal Int-XRST is then changed from the high level to the low level. The en bloc precharging period TPR1 is thereby started. The en bloc precharging period TPR1 can be reworded as a precharging period TPR1.

When the transfer clock CKV thereafter changes from a high level to a low level in a pulse manner, the second shift register S/R_d generates the transfer signal trn_d2, and supplies the transfer signal trn_d2 to the third shift register S/R_d. The transfer signal trn_dx (x=1, . . . , m) is thus sequentially transferred from the first shift register S/R_d to the (m)th shift register S/R_d. The transfer signal trn_dm generated from the (m)th shift register S/R_d is supplied to the first shift register S/R. Here, when the transfer signal trn_dm-2 is changed from a low level to a high level, the internal reset signal Int-XRST is changed from the low level to the high level. The en bloc precharging period TPR1 is thereby ended.

In the en bloc precharging period TPR1, the gate line driving circuits GD1 to GD2n set all of the gate lines (Gate_1, . . . , Gate_2n) in a high level selected state irrespective of the signal levels of the first enable signal EN1 and the second enable signal EN2. At this time, the gradation signal corresponding to the gray (Gray) is supplied from all of the source terminals (S1, S2, . . . ) of the source line driver 100 to the corresponding signal lines (Sg1, Sg3: Sg2, Sg4, . . . ) on the basis of high levels of the first selection signal MUX1 and the second selection signal MUX2. The pixel electrodes (P1, P2, . . . ) of all of the pixels PIX are thereby precharged en bloc with the gradation signal corresponding to the gray (Gray) (Gray precharge). When the en bloc precharging period TPR1 is ended, the gate line driving circuits GD1 to GD2n set all of the gate lines (Gate_1, . . . , Gate_2n) in a low level non-selected state on the basis of the high level of the internal reset signal Int-XRST.

Here, a period from an end of the en bloc precharging period TPR1 to the generation of the transfer signal trn_1 in the first shift register S/R is set as a reset releasing period TRR. The reset releasing period TRR is a period of simultaneous reset releasing of all of the circuits of the display gate driver 101. Therefore, a sufficient time is preferably secured as the reset releasing period TRR in consideration of time constants of all of the circuits of the display gate driver 101.

After an end of the reset releasing period TRR, a period T11 is started in which gate line scanning (Scan) of the display gate driver 101 is performed. In the period T11, a gradation signal for effective display is written to each pixel.

In the period T11, when the transfer clock CKV changes from a low level to a high level, the first shift register S/R that has received the transfer signal trn_dm generates the transfer signal trn_1, and supplies the transfer signal trn_1 to the second shift register S/R. When the transfer clock CKV thereafter changes from the high level to the low level, the second shift register S/R generates the transfer signal trn_2, and supplies the transfer signal trn_2 to the third shift register S/R. The transfer signal trn_x (x=1, . . . , n) is thus sequentially transferred from the first shift register S/R to the (n)th shift register S/R.

When the transfer signal trn_1 is at a high level, and the first enable signal EN1 is at a high level, the gate line Gate_1 is set in a selected state. At this time, gradation signals corresponding to a video signal are supplied to the signal lines Sg1 and Sg3 on the basis of a high level of the first selection signal MUX1, and therefore the gradation signals are written to the pixel electrodes P1 of corresponding pixels (plurality of pixels connected to the gate line Gate_1 and the signal lines Sg1, Sg3, . . . ). In addition, gradation signals corresponding to the video signal are supplied to the signal lines Sg2 and Sg4 on the basis of a high level of the second selection signal MUX2, and therefore the gradation signals are written to the pixel electrodes P2 of corresponding pixels (plurality of pixels connected to the gate line Gate_1 and the signal lines Sg2, Sg4, . . . ).

When the transfer signal trn_1 is at the high level, and the second enable signal EN2 is at a high level, the gate line Gate_2 is set in a selected state. At this time, gradation signals corresponding to the video signal are supplied to the signal lines Sg1 and Sg3 on the basis of a high level of the first selection signal MUX1, and therefore the gradation signals are written to the pixel electrodes P1 of corresponding pixels (plurality of pixels connected to the gate line Gate_2 and the signal lines Sg1, Sg3, . . . ). In addition, gradation signals corresponding to the video signal are supplied to the signal lines Sg2 and Sg4 on the basis of a high level of the second selection signal MUX2, and therefore the gradation signals are written to the pixel electrodes P2 of corresponding pixels (plurality of pixels connected to the gate line Gate_2 and the signal lines Sg2, Sg4, . . . ).

During a high level of the transfer signal trn_2, when the first enable signal EN1 is at a high level, the gate line Gate_3 is set in a selected state, and when the second enable signal EN2 is at a high level, the gate line Gate_4 is set in a selected state. At this time, gradation signals corresponding to the video signal are supplied to the signal lines Sg1 and Sg3 on the basis of a high level of the first selection signal MUX1, and therefore the gradation signals are written to the pixel electrodes P1 of corresponding pixels (plurality of pixels connected to the gate line Gate_3 or Gate_4 and the signal lines Sg1, Sg3, . . . ). In addition, gradation signals corresponding to the video signal are supplied to the signal lines Sg2 and Sg4 on the basis of a high level of the second selection signal MUX2, and therefore the gradation signals are written to the pixel electrodes P2 of corresponding pixels (plurality of pixels connected to the gate line Gate_3 or Gate_4 and the signal lines Sg2, Sg4, . . . ).

Thereafter, similarly, during high levels of the transfer signals trn_3, . . . , trn_n, corresponding gate lines are selected on the basis of the first enable signal EN1 and the second enable signal EN2, gradation signals corresponding to the video signal are supplied to the corresponding signal lines on the basis of the first selection signal MUX1 and the second selection signal MUX2, and the gradation signals are written to the pixel electrodes (P1 and P2) of corresponding pixels (plurality of pixels connected to the corresponding gate lines and the corresponding signal lines).

After gradation signals are written to the plurality of pixels connected to the gate line Gate_2n (after an end of the period T11), the period T12 and the period T13 arrive, as described with reference to FIG. 3.

Thus, the pixel electrodes (P1, P2, . . . ) of all of the pixels PIX are precharged en bloc with the gradation signal corresponding to the gray (Gray) in the precharging period TPR1. Thereafter, in the period T11, the gradation signals corresponding to the video signal are written to the pixel electrodes (P1, P2, . . . ) of all of the pixels PIX. Then, liquid crystal response to a gradation signal of a white color, a gradation signal of a black color, or a gradation signal corresponding to another gradation Gray can be completed early in the liquid crystal molecule response period T12. Hence, a technology that enables an improvement in moving image characteristics can be provided.

Next, referring to FIG. 7 and FIG. 8, a description will be made of an example of a circuit configuration of a gate line selecting circuit GL (GL1 to GL2n) and a gate line driving circuit GD (GD1 to GD2n) within the display gate driver 101 and operation of the display gate driver 101.

As illustrated in FIG. 7, the gate line selecting circuit GL includes an inverter IV1, a P-channel transistor Q1, an N-channel transistor Q2, and an N-channel transistor Q3.

An output terminal of a shift register S/R from which output terminal a transfer signal trn is output is connected to an input terminal of the inverter IV1, a gate terminal of the transistor Q1, and a gate terminal of the transistor Q3. A source terminal of the transistor Q1 is connected so as to receive the internal reset signal Int-XRST. A source-drain path of the transistor Q1 and a source-drain path of the transistor Q3 are connected in series with each other. A source terminal of the transistor Q3 is connected to wiring supplied with a low potential VGL such as a low level of the gate line Gate i. A source-drain path of the transistor Q2 is connected in parallel with the source-drain path of the transistor Q1. A gate terminal of the transistor Q2 is connected to an output terminal of the inverter IV1 that outputs an inverted signal xtrn of the transfer signal trn.

The gate line driving circuit GD includes a P-channel transistor Q4, an N-channel transistor Q5, an N-channel transistor Q6, and a P-channel transistor Q7. A source terminal of the transistor Q4 is connected so as to receive the first enable signal EN1 (or the second enable signal EN2). A drain terminal of the transistor Q4 is connected to the gate line Gate i. A source-drain path of the transistor Q4 and a source-drain path of the transistor Q6 are connected in series with each other. A gate terminal of the transistor Q6 is connected to a drain terminal of the transistor Q1. A source terminal of the transistor Q6 is connected to the wiring supplied with the low potential VGL such as the low level of the gate line Gate i. A source-drain path of the transistor Q5 is connected in parallel with the source-drain path of the transistor Q4. A gate terminal of the transistor Q5 is connected to the gate terminal of the transistor Q1. A gate terminal of the transistor Q7 is connected so as to receive the internal reset signal Int-XRST. A source-drain path of the transistor Q7 is connected between wiring supplied with a high potential VGH such as a high level of the gate line Gate i and the gate line Gate i.

As illustrated in FIG. 8, as in FIG. 6, operation of the display gate driver 101 includes a discharging (discharge) period, an en bloc precharging period TPR1, a reset releasing period TRR, and a period T11 in which gate line scanning (Scan) of the display gate driver 101 is performed.

First, the discharging (discharge) period arrives when the internal reset signal Int-XRST is set to a low level. At this time, the transistor Q7 is turned on, and thereby the gate line Gate i is set in a high level selected state. Incidentally, because the transfer signal trn is at a low level, and the inverted signal xtrn thereof is at a high level, the transistors Q1 and Q2 are turned on, the transistor Q3 is turned off, a signal trnR is at a low level, and the transistors Q4, Q5, and Q6 are turned off.

After an end of the discharging (discharge) period, the internal reset signal Int-XRST is set to a high level. The transfer signal trn is at a low level, and the inverted signal xtrn thereof is at a high level. Therefore, the transistors Q1 and Q2 are turned on, the transistor Q7 is turned off, and the signal trnR is set to a high level. Thus, the transistor Q6 is turned on, and the gate line Gate i is set in a low level non-selected state.

The en bloc precharging period TPR1 thereafter arrives. At this time, the internal reset signal Int-XRST is set to a low level. Thus, as in the discharging (discharge) period, the transistor Q7 is turned on, and thereby the gate line Gate i is set in a high level selected state. Here, the transfer clock CKV, the first enable signal EN1, and the second enable signal EN2 start to be supplied. At this time, the source line driver 100 supplies the gradation signal corresponding to the gray (Gray) to all of the signal lines to perform precharging of all of the pixels.

The reset releasing period TRR thereafter arrives. At this time, the internal reset signal Int-XRST is set to a high level. The transfer signal trn is at a low level, and the inverted signal xtrn thereof is at a high level. As after the end of the discharging (discharge) period, the gate line Gate i is set in a low level non-selected state.

After an end of the reset releasing period TRR, the period T11 is started in which gate line scanning (Scan) of the display gate driver 101 is performed. In the period T11, a gradation signal for effective display is written to each pixel. Here, the internal reset signal Int-XRST is at a high level, the transfer signal trn is set to a high level, and the inverted signal xtrn thereof changes to a low level. Therefore, the transistors Q1 and Q2 are turned off, and the transistor Q7 is turned off. The transistors Q3, Q4, and Q5 are turned on, and the signal trnR is set to a low level. The transistor Q6 is therefore turned off. Because the transistors Q3 and Q4 are turned on, the gate line Gate i is set in a high level selected state on the basis of a high level of the first enable signal EN1 (or the second enable signal EN2).

### First Modification

In FIG. 4, the plurality of shift registers S/R within the display gate driver 101 are supplied with the internal reset signal Int-XRST. However, the reset signal XRST may be used to reset the plurality of shift registers S/R. In a first modification, a description will be made of an example of a configuration that supplies the reset signal XRST to the plurality of shift registers S/R.

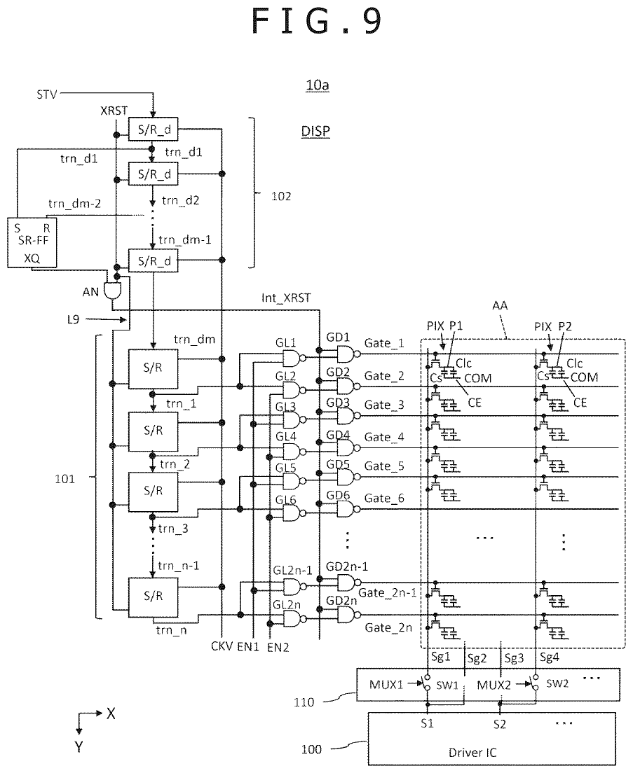

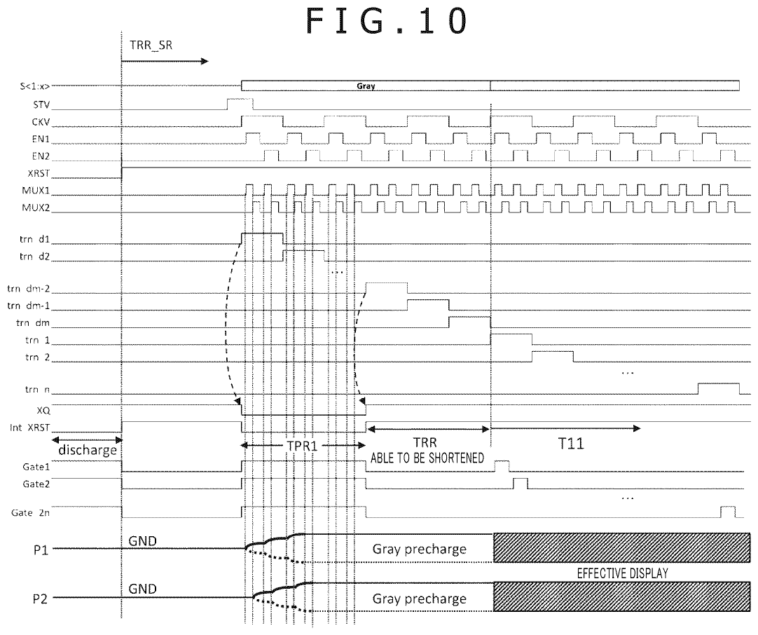

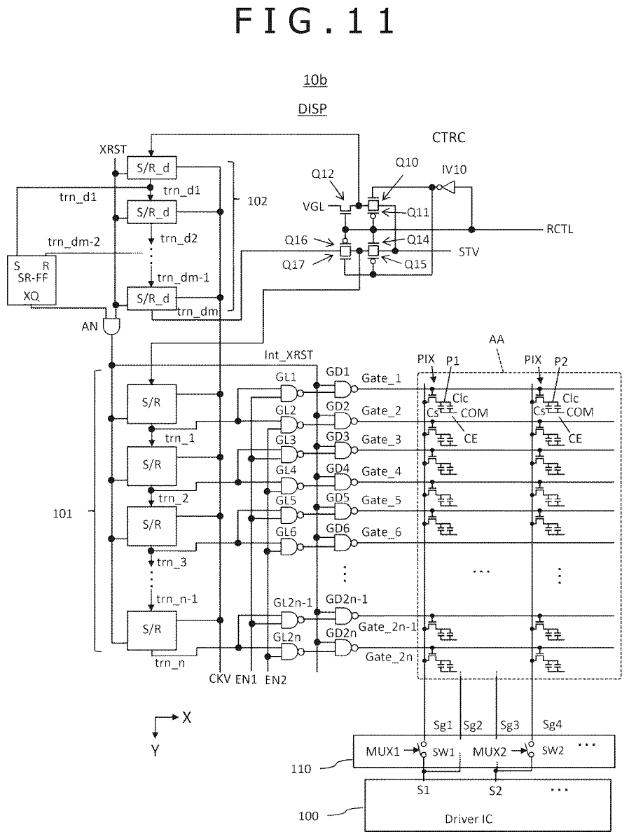

A display device according to the first modification will be described in the following with reference to FIG. 9 and FIG. 10. FIG. 9 is a diagram illustrating an example of a configuration of the display device according to the first modification. FIG. 10 is a diagram of assistance in explaining timings of the display device according to the first modification.

The display device 10a of FIG. 9 is different from the display device 10 of FIG. 4 in that the reset signal XRST is supplied to the plurality of shift registers S/R in the display device 10a. The other configuration of the display device 10a of FIG. 9 is the same as the other configuration of the display device 10 of FIG. 4, and therefore a repeated description thereof will be omitted.

In FIG. 9, wiring L9 is provided so as to supply the plurality of shift registers S/R with the reset signal XRST that is supplied to one terminal of the AND circuit AN.

A reset releasing operation can be performed on the plurality of shift registers S/R within the display gate driver 101 at a time point that the reset signal XRST is set to a high level.

It suffices for the internal reset signal Int-XRST to perform reset releasing of only the gate line driving circuit GD (GD1 to GD2n) as a final NAND circuit. It is therefore possible to shorten the reset releasing period (TRR).

The wiring L9 of the reset signal XRST needs to be formed also in a layout arrangement region of the display gate driver 101. Incidentally, when the number of pieces of wiring L9 is approximately one, the wiring L9 is considered not to have much effect on the layout arrangement.

The timings of the display device 10a of FIG. 10 are different from the timings of the display device 10 of FIG. 6 in that reset releasing (TRR_SR) of the plurality of shift registers S/R within the display gate driver 101 is provided after the discharging (discharge) period. The other timings of the display device 10a of FIG. 10 are the same as the other timings of the display device 10 of FIG. 4, and therefore a repeated description thereof will be omitted.

### Second Modification

In the first embodiment, a description has been made of the display device 10 that is provided with the additional shift register 102 and can thereby perform en bloc precharging. Here, when whether or not to execute the en bloc precharging is allowed to be selected, it is possible to perform an evaluation and then decide on either the execution or the non-execution after the fabrication of the display panel DISP in a case where the number of pixels and the driving frequency of the display panel DISP are such ones that it is difficult to determine which of the execution or the non-execution is preferable in a design stage.

In a second modification, a description will be made of an example of a configuration of a display device 10b that can select the “execution of the en bloc precharging” or the “non-execution of the en bloc precharging” on the basis of a control signal. FIG. 11 is a diagram illustrating an example of a configuration of the display device according to the second modification. The display device 10b of FIG. 11 is different from the display device 10 of FIG. 4 in that a control circuit CTRC is provided in the display device 10b. The other configuration of the display device 10b of FIG. 11 is the same as the other configuration of the display device 10 of FIG. 4, and therefore a repeated description will be omitted.

Operation of the control circuit CTRC is controlled by a control signal RCTL. When the control signal RCTL is at a high level, the control circuit CTRC is configured so as to supply the start pulse STV to the first shift register S/R within the display gate driver 101, and therefore the display device 10b without the en bloc precharging is formed. On the other hand, when the control signal RCTL is at a low level, the control circuit CTRC is configured so as to supply the start pulse STV to the first shift register S/R_d of the additional shift register 102, and is configured so as to supply the transfer signal trn_dm output by the (m)th shift register S/R_d of the additional shift register 102 to the first shift register S/R within the display gate driver 101, and therefore the display device 10b having the en bloc precharging is formed. That is, the control circuit CTRC can be regarded as a control circuit that controls the enabling and disabling of the additional shift register 102.

The control circuit CTRC includes an inverter IV10, N-channel transistors Q10, Q12, Q14, and Q17, and P-channel transistors Q11, Q15, and Q16.

An input terminal of the inverter IV10 is connected to wiring supplied with the control signal RCTL. An output terminal of the inverter IV10 is connected to respective gate terminals of the transistors Q10, Q15, and Q17. Respective gate terminals of the transistors Q11, Q12, Q14, and Q16 are connected to the wiring supplied with the control signal RCTL.

A source-drain path of the transistor Q10 is connected in parallel with a source-drain path of the transistor Q11, and is connected in series with a source-drain path of the transistor Q12.

The source-drain path of the transistor Q10 is connected to wiring supplied with the start pulse STV. The source-drain path of the transistor Q12 is connected to wiring supplied with the low potential VGL such as a low level of the gate line Gate. A common point of connection between the source-drain path of the transistor Q10 and the source-drain path of the transistor Q12 is connected to an input terminal of the first shift register S/R_d of the additional shift register 102.

A source-drain path of the transistor Q14 is connected in parallel with a source-drain path of the transistor Q15, and is connected in series with a source-drain path of the transistor Q16. The source-drain path of the transistor Q16 is also connected in parallel with a source-drain path of the transistor Q17. The source-drain path of the transistor Q14 is connected to the wiring supplied with the start pulse STV. The source-drain path of the transistor Q16 is connected to wiring supplied with the transfer signal trn_dm. A common point of connection between the source-drain path of the transistor Q14 and the source-drain path of the transistor Q16 is connected to an input terminal of the first shift register S/R within the display gate driver 101.

When the control signal RCTL is at a high level, the transistors Q12, Q14, and Q15 are turned on, and the transistors Q10, Q11, Q16, and Q17 are turned off. Thus, the start pulse STV is supplied to the input terminal of the first shift register S/R within the display gate driver 101, and the input terminal of the first shift register S/R_d of the additional shift register 102 is supplied with the low potential VGL such as a low level. Hence, the display device 10b is set in a configuration without the en bloc precharging.

When the control signal RCTL is at a low level, the transistors Q10, Q11, Q16, and Q17 are turned on, and the transistors Q12, Q14, and Q15 are turned off. Thus, the start pulse STV is supplied to the input terminal of the first shift register S/R_d of the additional shift register 102, and the transfer signal trn_dm output by the (m)th shift register S/R_d of the additional shift register 102 is supplied to the input terminal of the first shift register S/R within the display gate driver 101. Hence, the display device 10b is set in a configuration provided with the en bloc precharging.

### Third Modification

In a third modification, consideration is given to a configuration in which the additional shift register 102 is provided to a display device 10c (10, 10a, 10b).

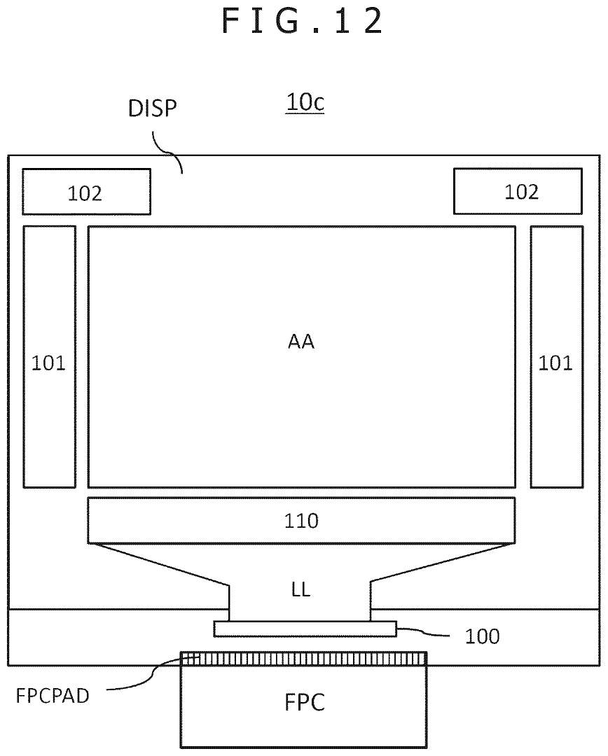

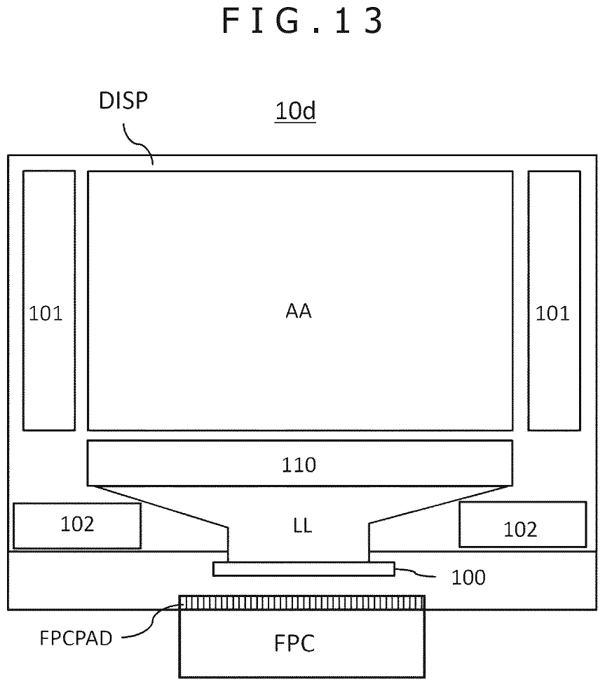

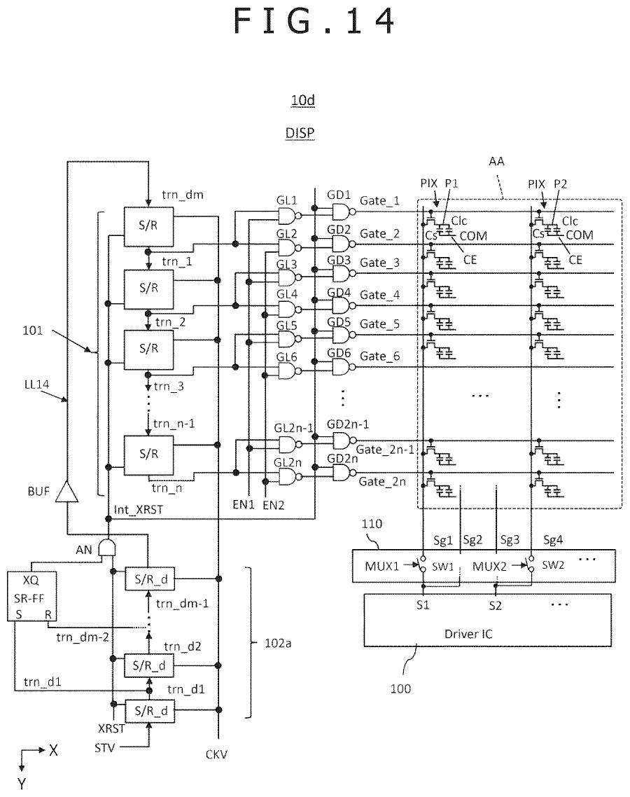

FIG. 12 is a plan view schematically illustrating a first configuration example of the display device according to the third modification. FIG. 13 is a plan view schematically illustrating a second configuration example of the display device according to the third modification. FIG. 14 is a diagram of assistance in explaining an example of a circuit configuration corresponding to the second configuration example of the display device of FIG. 13.

As illustrated in FIG. 12, in the display panel DISP, as viewed in plan, the active region AA in a rectangular shape is disposed at a central part of the display panel DISP, and the display gate driver 101 is arranged in a left side region and a right side region of the active region AA. The present example represents a configuration in which there is a margin in an upper region of the active region AA. Thus, the additional shift register 102 is arranged at two positions in a region on the upper side of the active region AA which upper side corresponds to the upper side of the display gate driver 101 (opposite side from the source line driver 100 with respect to the display gate driver 101). The multiplexer 110 is disposed in a region on the lower side of the active region AA.

The display panel DISP is provided with a pad FPCPAD for connection to a flexible printed circuit board FPC, and is connected to the flexible printed circuit board FPC. The multiplexer 110 and the source line driver 100 are arranged between the pad FPCPAD and the active region AA. Wiring LL is disposed between the source line driver 100 and the multiplexer 110. Though not illustrated in the figure, wiring is disposed also between the source line driver 100 and the pad FPCPAD.

A display device 10d of FIG. 13 is different from the display device 10c of FIG. 12 in that, as viewed in plan, the arrangement regions of the additional shift register 102 are arranged in regions at two positions corresponding to the lower side of the display gate driver 101 (same side as the source line driver 100 with respect to the display gate driver 101). In a case where the region on the upper side of the active region AA is narrow, and the regions for arranging the additional shift register 102 cannot be provided in the region on the upper side of the active region AA, the additional shift register 102 is preferably arranged in the regions at the two positions corresponding to the lower side of the display gate driver 101 (regions at two positions on the lower edge side of the display panel DISP), as illustrated in FIG. 13. The other configuration of the display device 10d of FIG. 13 is the same as the other configuration of the display device 10c of FIG. 12, and therefore a repeated description thereof will be omitted.

The circuit configuration example corresponding to the second configuration example of the display device 10d illustrated in FIG. 14 is different from the circuit configuration example of the display device 10 of FIG. 4 in that an additional shift register 102a is disposed on the lower side of the display gate driver 101, and the transfer signal trn_dm output by the (m)th shift register S/R_d of the additional shift register 102a is supplied to the input terminal of the first shift register S/R within the display gate driver 101 via relatively long wiring LL14. The additional shift register 102a is disposed in regions at two positions corresponding to the lower side of the display gate driver 101 in FIG. 13 (parts of the additional shift register 102 in FIG. 13). Because the relatively long wiring LL14 is used, a buffer circuit BUF is preferably provided at a midpoint of the wiring LL14 to amplify and transmit the transfer signal trn_dm. The other configuration of the display device 10d of FIG. 14 is the same as the other configuration of the display device 10 of FIG. 4, and therefore a repeated description will be omitted.

### Fourth Modification

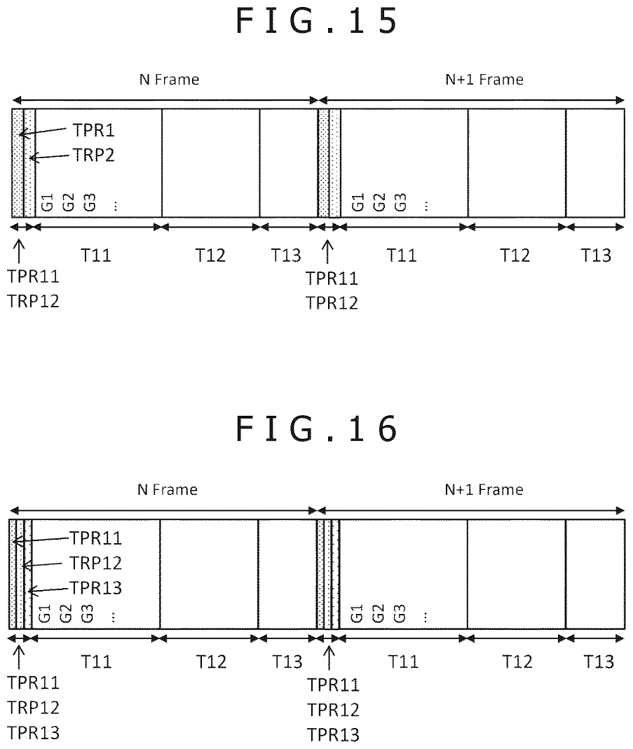

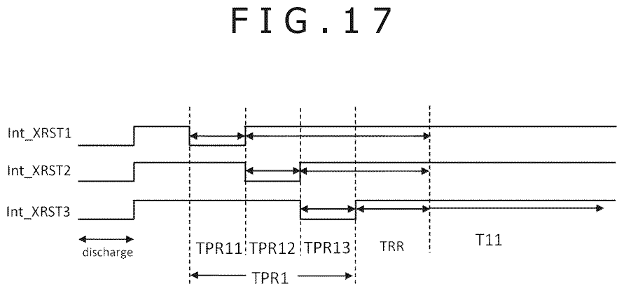

In a fourth modification, a description will be made of a configuration in which the en bloc precharging period is not one period but is divided into a plurality of periods. FIG. 15 is a diagram illustrating a configuration example in which the en bloc precharging period is divided into halves. FIG. 16 is a diagram illustrating a configuration example in which the en bloc precharging period is divided into thirds. FIG. 17 is a diagram illustrating a configuration example in which the number of signal systems of the internal reset signal Int-XRST is increased according to the number of divisions of the en bloc precharging period.

There is a method that divides the en bloc precharging period TPR1 into halves (FIG. 15: TPR11 and TPR12), thirds (FIG. 16: TPR11, TPR12, and TPR13), . . . , and performs precharging with different gradation potentials in a case where a difference in liquid crystal response between the upper and lower sides of the screen is not sufficiently filled even when the en bloc precharging is performed.

In a first en bloc precharging period (first precharging period) TPR11, as in the en bloc precharging period TPR1, all of the pixels are precharged with the gradation signal corresponding to the gray (Gray). The precharging gradation signal can be reworded as a third gradation signal between a first gradation signal corresponding to a black color and a second gradation signal corresponding to a white color. In a second en bloc precharging period (second precharging period) TPR12, all of the pixels are precharged with, for example, a fourth gradation signal between the second gradation signal and the third gradation signal. In a third en bloc precharging period (third precharging period) TPR13, all of the pixels are precharged with a fifth gradation signal between the second gradation signal and the fourth gradation signal. Alternatively, in the second en bloc precharging period TPR12, all of the pixels are precharged with, for example, the fourth gradation signal between the first gradation signal and the third gradation signal. In the third en bloc precharging period TPR13, all of the pixels are precharged with the fifth gradation signal between the first gradation signal and the fourth gradation signal.

In such a case, as illustrated in FIG. 17, the number of signal systems, that is, the number of divisions of the internal reset signal Int-XRST is preferably increased, as in a case of a first internal reset signal Int-XRST1, a second internal reset signal Int-XRST2, and a third internal reset signal Int-XRST3, according to the number of divisions of the en bloc precharging period.

Understanding is facilitated by referring to the circuit configuration of the display device 10a of FIG. 9. A configuration can be adopted such that, for example, of the gate line driving circuits GD1 to GD2n, gate line driving circuits GD1 to GDi are supplied with the first internal reset signal Int-XRST1, gate line driving circuits GD(i+1) to GDl are supplied with the second internal reset signal Int-XRST2, and gate line driving circuits GD(l+1) to GD2n are supplied with the third internal reset signal Int-XRST3. The gate line driving circuits GD1 to GDi can select a first plurality of gate lines (Gate_1, . . . , Gate_i) among the plurality of gate lines (Gate_1, . . . , Gate_2n). The gate line driving circuits GD(i+1) to GDl can select a second plurality of gate lines (Gate_i+1, . . . , Gate_l) among the plurality of gate lines (Gate_1, . . . , Gate_2n). The gate line driving circuits GD(l+1) to GD2n can select a third plurality of gate lines (Gate_l+1, . . . , Gate_2n) among the plurality of gate lines (Gate_1, . . . , Gate_2n).

Three sets each including the set-reset flip-flop (SR-FF) and the AND circuit AN are prepared to be able to generate the first internal reset signal Int-XRST1 by a first set, generate the second internal reset signal Int-XRST2 by a second set, and generate the third internal reset signal Int-XRST3 by a third set.

A first set-reset flip-flop (SR-FF) of the first set has a set terminal S supplied with the transfer signal trn_d1, and has a reset terminal R supplied with the transfer signal trn_di. The first internal reset signal Int-XRST1 is generated from a first AND circuit AN of the first set.

A second set-reset flip-flop (SR-FF) of the second set has a set terminal S supplied with the transfer signal trn_d(i+1), and has a reset terminal R supplied with the transfer signal trn_dl. The second internal reset signal Int-XRST2 is generated from a second AND circuit AN of the second set.

A third set-reset flip-flop (SR-FF) of the third set has a set terminal S supplied with the transfer signal trn_d(l+1), and has a reset terminal R supplied with the transfer signal trn_dm-2. The third internal reset signal Int-XRST3 is generated from a third AND circuit AN of the third set.

Thus, precharging with different gradation potentials is performed in the respective en bloc precharging periods divided according to the number of divisions of the en bloc precharging period. It is therefore possible to reduce the difference in liquid crystal response between the upper and lower sides of the screen sufficiently. Thus, a technology that enables an improvement in moving image characteristics can be provided.

All of display devices that can be implemented by those skilled in the art by making design changes as appropriate on the basis of the display devices described above as embodiments of the present disclosure also belong to the scope of the present disclosure as long as including the spirit of the present disclosure.

A person skilled in the art can conceive various kinds of modification examples and correction examples in a category of ideas of the present disclosure. It is therefore to be understood that those modification examples and correction examples also belong to the scope of the present disclosure. For example, embodiments obtained by a person skilled in the art by adding, deleting, or making design changes in constituent elements or adding, omitting, or making condition changes in processes as appropriate in each of the foregoing embodiments are included in the scope of the present disclosure as long as including the spirit of the present disclosure.

In addition, it is to be understood that other actions and effects that are produced by modes described in the present embodiments and that are obvious from the description of the present specification or can be conceived as appropriate by those skilled in the art are naturally produced by the present disclosure.

Various disclosures can be formed by appropriate combinations of a plurality of constituent elements disclosed in the foregoing embodiments. For example, a few constituent elements may be deleted from all of the constituent elements illustrated in the embodiments. Further, constituent elements of the different embodiments may be combined with each other as appropriate.

What is claimed is:

1. A display device comprising:
a plurality of gate lines extending in a first direction and juxtaposed to each other in a second direction intersecting the first direction;
a plurality of signal lines extending in the second direction and juxtaposed to each other in the first direction;
a plurality of pixels arranged in a form of a matrix in the first direction and the second direction;
a display gate driver configured to sequentially scan the plurality of gate lines; and
a precharging gate line selecting unit configured to select the plurality of gate lines en bloc,
one frame including
a precharging period in which the precharging gate line selecting unit selects the plurality of gate lines en bloc, and a precharging gradation signal is written to the plurality of pixels from the plurality of signal lines,
a first period in which, after the precharging period, the display gate driver sequentially scans the plurality of gate lines, and gradation signals corresponding to a video signal are written to the plurality of pixels from the plurality of signal lines, and
a second period in which, after the first period, none of the plurality of gate lines is selected.

2. The display device according to claim 1, wherein
the precharging gradation signal corresponds to a third gradation signal between a first gradation signal corresponding to a black color and a second gradation signal corresponding to a white color.

3. The display device according to claim 2, wherein
the precharging period includes a first precharging period and a second precharging period after the first precharging period,
in the first precharging period, a first plurality of gate lines among the plurality of gate lines are selected, and the third gradation signal is written to all of pixels connected to the first plurality of gate lines from the plurality of signal lines, and
in the second precharging period, a second plurality of gate lines different from the first plurality of gate lines among the plurality of gate lines are selected, and a fourth gradation signal between the third gradation signal and the second gradation signal is written to all of pixels connected to the second plurality of gate lines from the plurality of signal lines.

4. The display device according to claim 1, further comprising a display panel, wherein
the display panel has an active region including the plurality of gate lines, the plurality of signal lines, and the plurality of pixels, and
in the display panel, as viewed in plan,
the active region in a rectangular shape is disposed at a central part of the display panel,
the display gate driver is disposed in a left side region and a right side region of the active region, and
the precharging gate line selecting unit is disposed in a region corresponding to an upper side of the display gate driver.

5. The display device according to claim 1, further comprising a display panel, wherein
the display panel has an active region including the plurality of gate lines, the plurality of signal lines, and the plurality of pixels, and
in the display panel, as viewed in plan,
the active region in a rectangular shape is disposed at a central part of the display panel,
the display gate driver is disposed in a left side region and a right side region of the active region, and
the precharging gate line selecting unit is disposed in a region corresponding to a lower side of the display gate driver.

6. The display device according to claim 1, further comprising a source line driver configured to supply the gradation signals to the plurality of signal lines.

7. The display device according to claim 1, further comprising a control circuit configured to control enabling and disabling of the precharging gate line selecting unit.
